(19) United States
(12) Patent Application Publication
(10) Pub. No.: US 2022/0099998 A1
(43) Pub. Date: Mar. 31, 2022

(54) EYEWEAR HINGE DEVICE

(71) Applicant: Shih-Yun Huang, Brooklyn, NY (US)

(72) Inventor: Shih-Yun Huang, Brooklyn, NY (US)

(21) Appl. No.: 17/474,707

(22) Filed: Sep. 14, 2021

Related U.S. Application Data
(60) Provisional application No. 63/083,326, filed on Sep. 25, 2020.

(51) Int. Cl. G02C 5/22

(52) U.S. Cl. CPC G02C 5/2209

(57) ABSTRACT

An eyewear hinge device may include a first assembly having a first and second pin bridge which may both be coupled to a first object. A friction plate may be coupled to the first object and positioned between the pin bridges, and the friction plate may extend toward the stop plate. A first channel may extend around the friction plate. The friction plate may comprise a friction pocket and a friction ridge. A second assembly having a first and second lock arm may be coupled to a second object. The first lock arm may have a first lock pin and a first arm extension, and the second lock arm may have a second lock pin and a second arm extension. The first assembly may be movably coupled to the second assembly by positioning the first lock pin in the first pin aperture and the second lock pin in the second pin aperture.

### CROSS REFERENCE TO RELATED APPLICATIONS

This application claims priority to and the benefit of the filing date of U.S. Provisional Application No. 63/083,326, filed on Sep. 25, 2020, entitled “EYEWEAR HINGE DEVICE”, which is hereby incorporated by reference in its entirety.

### FIELD OF THE INVENTION

This patent specification relates to the field of hinges and movable couplings. More specifically, this patent specification relates to a hinge device that does not require the use of screws and which may be used to movably couple objects together, such as a temple arm and a lens frame of eyewear.

### BACKGROUND

Eyewear, such as reading glasses, prescription glasses, and sunglasses are worn daily by many people. However, existing eyewear suffers from many drawbacks which may be caused, at least in part, from utilizing screws in the hinge that movably couples a temple arm and a lens frame of eyewear. Upon repeated use, these screws tend to loosen which can result in a loose connection between the temple arm and a lens frame. If this is not caught in time, the screws can easily fall out and become lost creating expense and hassle for the owner. Additionally, lightweight eyewear that relies on screws typically causes the eyewear to have a fragile construction, while more robust eyewear that relies on screws is often found to be heavy due to the increased size and number of components.

Therefore, a need exists for a novel hinge device that does not require the use of screws and which may be used to movably couple objects together, such as a temple arm and a lens frame of eyewear. A further need exists for a novel hinge device that allows for a robust movable coupling for eyewear without relying on an increase in size, weight, and number of components.

### BRIEF SUMMARY OF THE INVENTION

An eyewear hinge device is provided which may provide a movable coupling between a first object and a second object. Preferably, a first object may be the lens frame of an article of eyewear and the second object may be a temple arm for the article of eyewear. Optionally, a first and second object may be any other type of objects, such as portions of a headband, foldable electronic headset, headlamp, glove box lid, various types of case lids, etc.

In some embodiments, the device may be movable between a first position and a second position, and the device may include a first assembly that may be coupled to a first object and a second assembly that may be coupled to a second object. The first assembly may have a first pin bridge and a second pin bridge which may both be coupled to the first object, a stop plate, a friction plate, and a first channel. The first pin bridge may include a first pin aperture, and the second pin bridge may include a second pin aperture. The stop plate may be coupled to both pin bridges so that the stop plate is distal to the first object. The friction plate may be coupled to the first object and positioned between the pin bridges, and the friction plate may extend towards the stop plate. The first channel may extend around the friction plate separating the friction plate from the pin bridges and from the stop plate. The friction plate may include a friction pocket and a friction ridge, and the friction ridge may be positioned between the first object and the friction pocket. The second assembly may include a first lock pin, second lock pin, and first lock arm. The first lock pin and second lock pin may extend away from each other. The first lock arm may be coupled to the second object and may have a first arm extension. The first lock pin may be coupled to the first lock arm, and the first arm extension may form a portion of the first lock arm that is most distal to the second object. The first assembly may be movably coupled to the second assembly by positioning the first lock pin in the first pin aperture and the second lock pin in the second pin aperture.

In further embodiments, the device may include a second lock arm that may be coupled to the second object, and the second lock arm may have a second arm extension. The second lock pin may be coupled to the second lock arm, and the second arm extension may form a portion of the second lock arm that is most distal to the second object.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts a first perspective view of an example of an eyewear hinge device in a first position according to various embodiments described herein.

FIG. 2—FIG. 2 illustrates a second perspective view of an example of an eyewear hinge device in a first position according to various embodiments described herein.

FIG. 3—FIG. 3 shows a perspective view of an example of an eyewear hinge device in a second position according to various embodiments described herein.

FIG. 4—FIG. 4 depicts a first perspective view of an example of a first assembly of an eyewear hinge device according to various embodiments described herein.

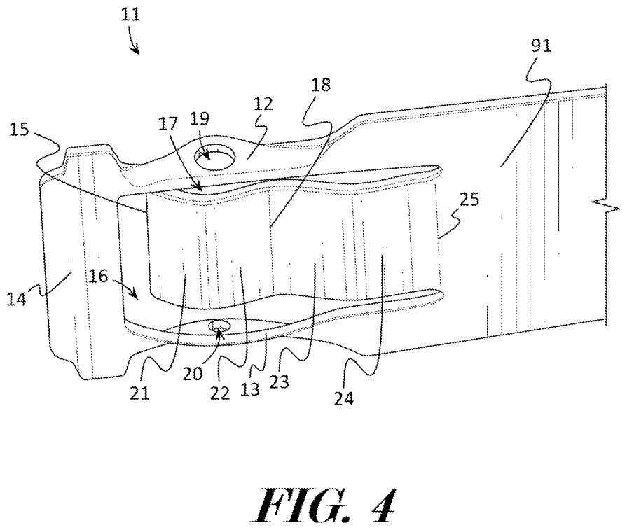

FIG. 5—FIG. 5 illustrates a second perspective view of an example of a first assembly of an eyewear hinge device according to various embodiments described herein.

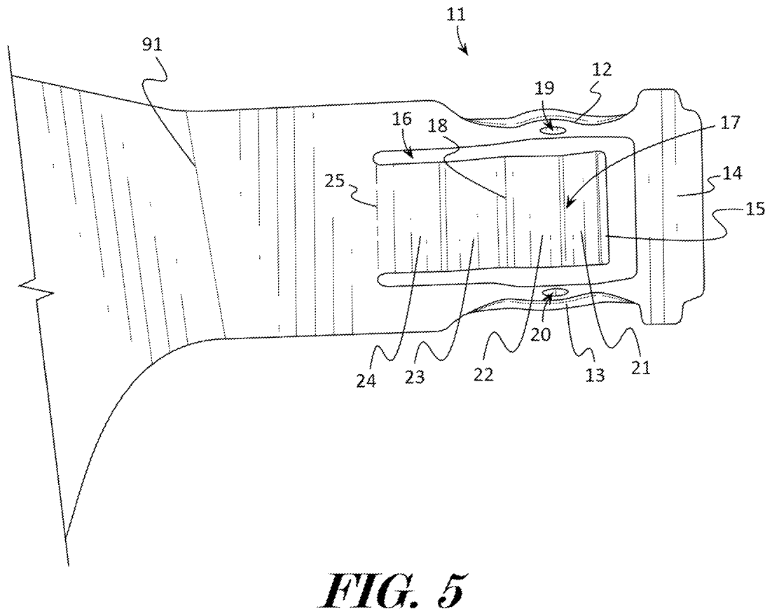

FIG. 6—FIG. 6 shows a perspective view of an example of a second assembly of an eyewear hinge device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

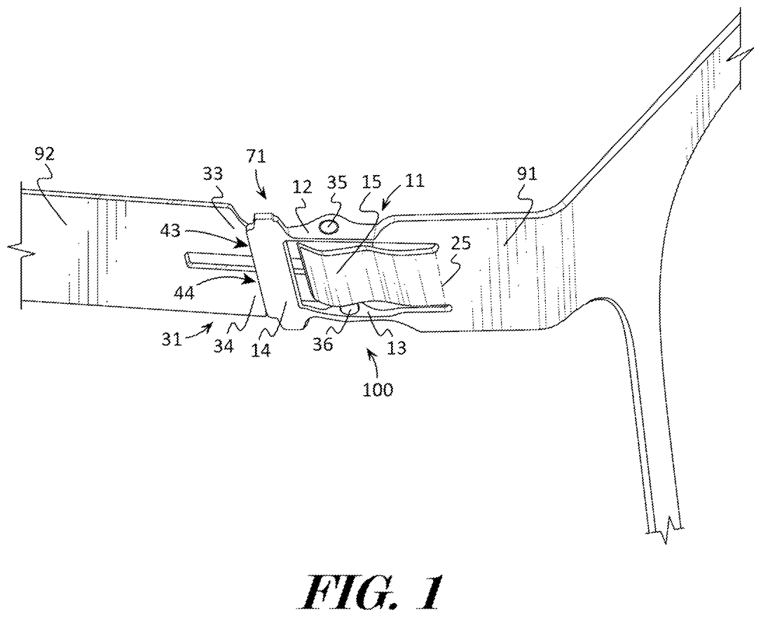

For purposes of description herein, the terms “upper,” “lower,” “left,” “right,” “rear,” “front,” “side,” “vertical,” “horizontal,” and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new eyewear hinge device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

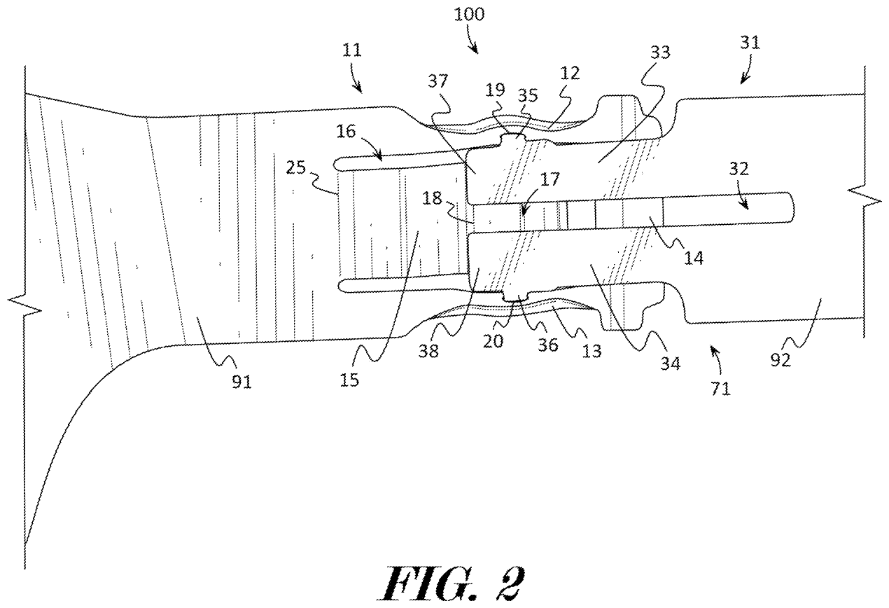

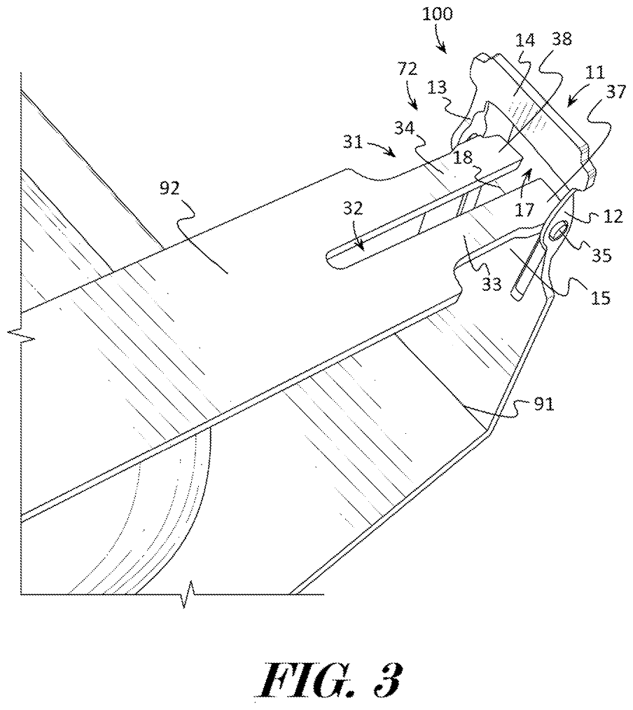

The present invention will now be described by example and through referencing the appended figures representing preferred and alternative embodiments. FIGS. 1-3 illustrate an example of an eyewear hinge device (“the device”) 100 according to various embodiments. In some embodiments, the device 100 may include a first assembly 11 coupled to a first object 91, such as a lens frame of an article of eyewear, and a second assembly 31 coupled to a second object 92, such as temple arm of an article of eyewear. The first assembly 11 may include a first pin bridge 12 and a second pin bridge 13 which may both be coupled to the first object 91. A stop plate 14 may be coupled to both pin bridges 12, 13, so that the stop plate 14 is distal to the first object 91. A friction plate 15 may be coupled to the first object 91 and positioned between the pin bridges 12, 13, and the friction plate 15 may extend toward the stop plate 14. A first channel 16 may extend around the friction plate 15 to separate the friction plate 15 from the pin bridges 12, 13, and stop plate 14. The friction plate 15 may comprise a friction pocket 17 and a friction ridge 18, and the friction ridge 18 may be positioned between the first object 91 and the friction pocket 17. Each pin bridge 12, 13, may comprise a pin aperture 19, 20. The pin apertures 18, 19, may be generally aligned with the friction pocket 17, while the friction ridge 18 may be positioned closer to the first object 91 than the friction pocket 17. The second assembly 31 may include a first lock arm 33 and a second lock arm 34 that may be coupled to the second object 92. The first lock arm 33 may have a first lock pin 35 and a first arm extension 37, and the second lock arm 34 may have a second lock pin 36 and a second arm extension 38. The lock arms 33, 34, may be separated from each other by a second channel 32, and the lock pins 35, 36, may extend away from each other. The extensions 37, 38, may form the portion of the lock arms 33, 34, that are most distal to the second object 92. The first assembly 11 may be movably coupled to the second assembly 31, so that the device 100 may be moved between a first position 71 (FIGS. 1 and 2) and a second position 72 (FIG. 3), by positioning the first lock pin 35 in the first pin aperture 19 and the second lock pin 36 in the second pin aperture 20. Preferably, when in the first position 71, the lock arms 33, 34, may be generally parallel to the pin bridges 12, 13, to the stop plate 14, and/or to the friction plate 15, and when in the second position 72, the lock arms 33, 34, may be generally perpendicular to the pin bridges 12, 13, to the stop plate 14, and/or to the friction plate 15. While in the second position 72, the extensions 37, 38, may be positioned in the friction pocket 17, and the extensions 37, 38, may cause the friction plate 15 to flex away from the arms 33, 34, thereby exerting pressure on the extensions 37, 38, to maintain the objects 91, 92, in the second position 72. Moving the device 100 into the first position 71 may move the extensions 37, 38, out of the friction pocket 17 so that the extensions 37, 38, rest against the friction ridge 18. The friction ridge 18 may press against the extensions 37, 38, causing portions of the lock arms 33, 34, to be tensioned against the stop plate 14 to maintain the device 100 in the first position 71.

In some embodiments, the device 100 may include a first assembly 11 coupled to a first object 91, such as a lens frame of an article of eyewear, and a second assembly 31 coupled to a second object 92, such as temple arm of an article of eyewear. In other embodiments, the device 100 may include a second assembly 31 coupled to a first object 91, such as a lens frame of an article of eyewear, and a first assembly 11 coupled to a second object 92, such as temple arm of an article of eyewear. Preferably, when in the first position 71, the objects 91, 92, may be generally perpendicular to each other, and when in the second position 72, the objects 91, 92, may be generally parallel to each other. In still other embodiments, a first assembly 11 and a second assembly 31 may be configured to movably couple any other type of objects 91, 92, together, such as portions of a headband, foldable electronic headset, headlamp, glove box lid, various types of case lids, etc.

The first assembly 11 may include a first pin bridge 12 and a second pin bridge 13 which may both be coupled to the first object 91 and which may both be coupled to stop plate 14. Each pin bridge 12, 13, may comprise a pin aperture 19, 20, which may be sized and shaped to receive a lock pin 35, 36. For example, a first lock pin 35 may be received in a first pin aperture 19 of a first pin bridge 12 and a second lock pin 36 may be received in a second pin aperture 20 of a second pin bridge 13. Preferably, the pin apertures 18, 19, may be generally vertically aligned with each other. The pin apertures 19, 20, may be sized and shaped to be slightly larger than the lock pins 35, 36, so that the lock pins 35, 36, may pivot within the pin apertures 19, 20, thereby allowing the lock pins 35, 36, and pin apertures 19, 20, to function as hinges while minimizing or preventing the lock pins 35, 36, from wobbling within the pin apertures 19, 20. Optionally, pin bridges 12, 13, and their respective pin apertures 19, 20, may be pressed, cut, machined, or otherwise formed into a first object 91 to generally define their respective sizes and shapes.

A stop plate 14 may be coupled to both pin bridges 12, 13, so that the stop plate 14 is distal to the first object 91. In this manner, the pin apertures 18, 19, of the pin bridges 12, 13, may be positioned between the stop plate 14 and the first object 91 that the pin bridges 12, 13, may be coupled to. Optionally, a stop plate 14 may be pressed, cut, machined, or otherwise formed into a first object 91 to generally define the size and shape of the stop plate 14. A stop plate 14 may be configured in any size and shape. Generally, a stop plate 14 may be shaped and/or positioned to arrest the movement of the lock arm(s) 33, 34, when the lock arm(s) 33, 34, are moved into the first position 71 to prevent over extension of the lock arm(s) 33, 34, and therefore, over extension of the second object 92 that may be coupled to the lock arm(s) 33, 34, relative to the first object 91. In preferred embodiments, a stop plate 14 may be shaped and/or positioned to arrest the movement of the lock arm(s) 33, 34, (thereby arresting extension of the second object 92 that is coupled to the lock arm(s) 33, 34) when moved into the first position 71 between approximately plus or minus 5.0 degrees relative to the first object 91 so that the lock arm(s) 33, 34, may be approximately parallel, and more preferably substantially parallel to the first object 91.

A friction plate 15 may be coupled to the first object 91 and positioned between the pin bridges 12, 13, and the friction plate 15 may extend toward the stop plate 14. A first channel 16 may extend around the friction plate 15 to separate the friction plate 15 from the pin bridges 12, 13, and stop plate 14. A friction plate 15 and first channel 16 may each be configured in any size and shape. Optionally, a first channel 16 may be pressed, cut, machined, or otherwise formed into a first object 91 to generally define the size and shape of the friction plate 15. Optionally, a friction plate 15 may be pressed, cut, machined, or otherwise formed into a first object 91 to generally define the size and shape of the friction plate 15.

In preferred embodiments, a friction plate 15 may comprise a friction pocket 17 and a friction ridge 18 with which one or more portions of one or more arm extensions 37, 38, of a second assembly 31 may interact with to control or guide the pivoting motion of the device 100 into and between the first 71 and second 72 positions. In further preferred embodiments, a friction ridge 18 may be positioned closer to the first object 91 and the friction pocket 17 may be positioned closer to the stop plate 14.

In some embodiments, a friction pocket 17 may be formed into a friction plate 15 to form a depression or recess in the friction plate 15 that one or more of the arm distal surfaces 39, 40, of the arm extensions 37, 38, of a second assembly 31 may fit into (as perhaps best shown in FIG. 3) when the device 100 is moved into the second position 72.

In some embodiments, a friction ridge 18 may form a protrusion or raised feature on the friction plate 15 that extends above the friction pocket 17. Generally, a friction ridge 18 may contact and press or tension against one or more extension surfaces 41, 42, of the arm extensions 37, 38, of a second assembly 31 when the device 100 is moved into the first position 71 (FIGS. 1 and 2). In this manner, the lock pins 35, 36, in the pin apertures 19, 20, may act as fulcrums for transferring the tension exerted by the friction ridge 18 against one or more extension surfaces 41, 42, of the arm extensions 37, 38, to tension the stop surfaces 43, 44, of the lock arms 33, 34, against the stop plate 14 (FIG. 1) so that the device 100 is tensioned in the first position 71. Preferably when the device 100 is in the first position 71: a first extension surface 41 may contact the friction ridge 18; a second extension surface may contact the friction ridge 18; a first stop surface 43 may contact the stop plate 14; and/or a second stop surface may contact the stop plate 14.

In some embodiments, a friction plate 15 may comprise one or more panels 21, 22, 23, 24, which may be sized/shaped/positioned to form one or more elements of a friction plate 15, such as a friction pocket 17 and a friction ridge 18. In further embodiments, one or more panels 21, 22, 23, 24, may be formed by bending or folding portions of the friction plate 15 so that the intersections of one or more panels 21, 22, 23, 24, may form a friction pocket 17 or a friction ridge 18. In further embodiments, a friction pocket 17 and a friction ridge 18 may be molded, machined, or formed with any other suitable method. In preferred embodiments, the pin apertures 18, 19, may be generally aligned with the friction pocket 17, while the friction ridge 18 may be positioned relatively closed to the first object 91 than the friction pocket 17.

In preferred embodiments, a friction plate 15 may comprise a first panel 21, a second panel 22, and a third panel 23. Optionally, a friction plate 15 may comprise a fourth panel 24. A first panel 21 may be formed by the portions of the friction plate 15 that may be most distal to the first object 91 that the friction plate 15 is coupled to. A second panel 22 may be formed by the portions of the friction plate 15 adjacent to the first panel 21. Preferably, the first panel 21 and second panel 22 may be angled relative to each other to form a friction pocket 17. A third panel 23 may be formed by the portions of the friction plate 15 adjacent to the second panel 22. Preferably, the second panel 21 and third panel 23 may be angled relative to each other to form a friction ridge 18. Optionally, the third panel 23 may be coupled to the first object 91 or the third panel 23 may be coupled to a fourth panel 24 that may be coupled to the first object 91. The portion of the third panel 23 or a fourth panel 24 that may be coupled to the first object 91 may form a “living hinge” 25 which typically comprise a linear, relatively flexible area between two relatively more rigid components, such as a line of thin plastic between thicker plastic portions, as is well known in the art, and the living hinge 25 may couple the friction plate 15 to the first object 91 and may allow the friction plate 15 to flex relative to the first object 91.

In preferred embodiments, the friction plate 15, first object 91, and other elements of the device 100 may comprise or be formed of Japanese steel, and more preferably Japanese stainless steel, such as ultra-thin 0.1 to 3.0 mm thick Japanese stainless steel, and more preferably approximately 0.5 mm thick Japanese stainless steel which is very durable and flexible, which may allow the third panel 23 or a fourth panel 24 that may be coupled to the first object 91 to function as a living hinge 25. Japanese stainless steel, sometimes referred to as VG-10, is a high-grade stainless steel made in Japan. The name stands for V Gold 10, literally meaning ‘gold quality’. It is steel with a high carbon content containing approximately 1% Carbon, approximately 15% Chromium, approximately 1% Molybdenum, approximately 0.2% Vanadium, approximately 1.5% Cobalt, and approximately 0.5% Manganese. In further preferred embodiments, the first assembly 11 and/or the second assembly 31 may comprise or may be made of steel, and more preferably Japanese stainless steel. In further embodiments, the first assembly 11 may be formed from a single sheet of steel that may be between approximately 0.1 to 3.0 mm, and more preferably approximately 0.5 mm thick, and the second assembly 31 may also be formed from a single sheet of steel that that may be between approximately 0.1 to 3.0 mm, and more preferably approximately 0.5 mm thick. In preferred embodiments, the first assembly 11 may be formed from a single sheet of Japanese stainless steel that may be between approximately 0.1 to 3.0 mm, and more preferably approximately 0.5 mm thick, and the second assembly 31 may also be formed from a single sheet of Japanese stainless steel that that may be between approximately 0.1 to 3.0 mm, and more preferably approximately 0.5 mm thick.

In further preferred embodiments, the first assembly 11 may be formed from a single sheet of steel, and more preferably Japanese stainless steel, that may be between approximately 0.1 to 3.0 mm, and more preferably approximately 0.5 mm thick, the second assembly 31 may also be formed from a single sheet of steel, and more preferably Japanese stainless steel, that that may be between approximately 0.1 to 3.0 mm, and more preferably approximately 0.5 mm thick, the first lock arm 33, and preferably the second lock arm 34, may be substantially parallel (approximately plus or minus 5.0 degrees) to at least one of the first pin bridge 12, second pin bridge 13, stop plate 14, and friction plate 15 when the device 100 is in the first position, and/or the first lock arm 33, and preferably the second lock arm 34, may be substantially perpendicular (approximately plus or minus 5.0 degrees) to at least one of the first pin bridge 12, second pin bridge 13, stop plate 14, and friction plate 15 when the device 100 is in the second position 72.

In preferred embodiments, a second assembly 31 may include a first lock arm 33 and a second lock arm 34 that may be coupled to the second object 92. In some embodiments, lock arms 33, 34, may be separated from each other by a second channel 32, and each lock arm 33, 34, may comprise a lock pin 35, 36, which may be received in the pin apertures 19, 20, of the first assembly 11.

In some embodiments, a first lock arm 33 may have a first lock pin 35, a first arm extension 37, a first arm distal surface 39, a first extension surface 41, and a first stop surface 43. A first arm extension 37 may form the portion of the first lock arm 33 that may be most distal to the second object 92, and the first arm distal surface 39 may form the portion of the first arm extension 37 that may be most distal to the second object 92. Generally, a first arm extension 37 may be positioned on the side of the first lock pin 35 opposite to the second object 92. A first extension surface 41 may comprise the portions of the first arm extension 37 that are between the first arm distal surface 39 and the first lock pin 35, while a first stop surface 43 may comprise the portions of the first lock arm 33 positioned opposite to the first extension surface 41 as separated by the first lock pin 35.

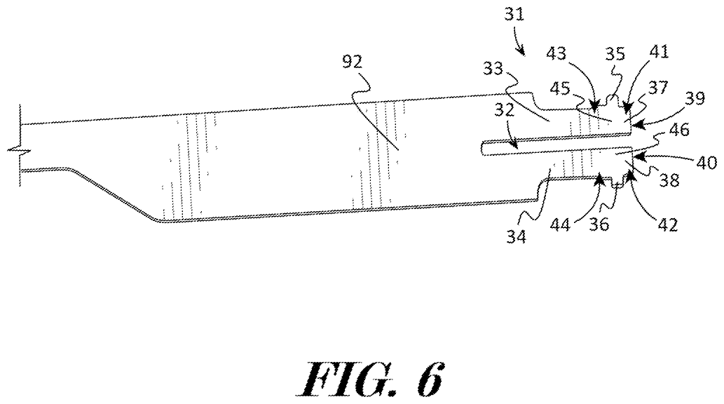

In some embodiments, a second assembly 31 may include a first lock arm 33 which may comprise a first lock pin 35 and a second lock pin 36 which may be received in the pin apertures 19, 20, of the first assembly 11. In preferred embodiments, the second assembly 31 may comprise a first lock arm 33 having a first lock pin 35 and a second lock arm 34 having a second lock pin 36. In some embodiments, the first lock pin 35 and second lock pin 36 may extend away from each other as perhaps best shown in FIG. 6. While a lock pin 35, 36, may be coupled to any portion of a lock arm 33, 34, in preferred embodiments, a first lock pin 35 may be coupled to the first lock arm 33 at a junction 45 of the first lock arm 33 and first arm extension 37 so that the junction 45 may separate the first extension surface 41 and first stop surface 43 and, likewise, a second lock pin 36 may be coupled to the second lock arm 34 at a junction 46 of the second lock arm 34 and second arm extension 38 so that the junction 46 may separate the second extension surface 42 and second stop surface 44.

Similarly, and in some embodiments, a second lock arm 34 may have a second lock pin 36, a second arm extension 38, a second arm distal surface 40, a second extension surface 42, and a second stop surface 44. A second arm extension 38 may form the portion of the second lock arm 34 that may be most distal to the second object 92, and the second arm distal surface 40 may form the portion of the second arm extension 38 that may be most distal to the second object 92. Generally, a second arm extension 38 may be positioned on the side of the second lock pin 36 opposite to the second object 92. A second extension surface 42 may comprise the portions of the second arm extension 38 that are between the second arm distal surface 40 and the second lock pin 36, while a second stop surface 44 may comprise the portions of the second lock arm 34 positioned opposite to the second extension surface 42 as separated by the second lock pin 36.

In preferred embodiments, the device 100 may comprise a first assembly 11 that may be movably coupled to a second assembly 31 by positioning the first lock pin 35 in the first pin aperture 19 and the second lock pin 36 in the second pin aperture 20. The second object 92 may be moved into and between a first position 71, in which the objects 91, 92, that the assemblies 11, 31, are coupled to are generally parallel to each other, and a second position 72 in which the objects 91, 92, are generally perpendicular to each other.

In preferred embodiments, while in the second position 72, the arm distal surfaces 39, 40, of the extensions 37, 38, may be positioned in the friction pocket 17 of the friction plate 15 of the first assembly 11, and the extensions 37, 38, may cause the friction plate 15 to flex away from the arms 33, 34, thereby exerting pressure on the extensions 37, 38, to maintain the objects 91, 92, in the second position 72. Moving the objects 91, 92, into the first position 71 may move the arm distal surfaces 39, 40, of the extensions 37, 38, out of the friction pocket 17 so that the extension surfaces 41, 42, of the extensions 37, 38, rest against the friction ridge 18 and so that the stop surfaces 43, 44, rest against the stop plate 14. The friction ridge 18 may press the against the extension surfaces 41, 42, causing the stop surfaces 43, 44, of the lock arms 33, 34, to be tensioned against the stop plate 14, via the fulcrum provided by the lock pins 35, 36, in the pin apertures 19, 20, to tension and maintain the device 100 in the first position 71.

While some exemplary shapes and sizes have been provided for elements of the device 100, it should be understood to one of ordinary skill in the art that the pin bridges 12, 13, stop plate 14, friction plate 15, lock arms 33, 34, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An eyewear hinge device that is movable between a first position and a second position, the device comprising:
a first assembly coupled to a first object, the first assembly having:
i. a first pin bridge and a second pin bridge which are both coupled to the first object, wherein the first pin bridge comprises a first pin aperture, and wherein the second pin bridge comprises a second pin aperture;
ii. a stop plate coupled to both pin bridges so that the stop plate is distal to the first object;
iii. a friction plate coupled to the first object and positioned between the pin bridges, and the friction plate extending towards the stop plate;
iv. a first channel extending around the friction plate separating the friction plate from the pin bridges and from the stop plate, wherein the friction plate comprises a friction pocket and a friction ridge, and wherein the friction ridge is positioned between the first object and the friction pocket; and
a second assembly coupled to a second object, the second assembly having:
i. a first lock pin and a second lock pin that extend away from each other; and
ii. a first lock arm coupled to the second object and having a first arm extension, wherein the first lock pin is coupled to the first lock arm,
wherein the first arm extension forms a portion of the first lock arm that is most distal to the second object, and wherein the first assembly is movably coupled to the second assembly by positioning the first lock pin in the first pin aperture and the second lock pin in the second pin aperture.

2. The device of claim 1, wherein the first arm extension comprises a first arm distal surface that is positioned in the friction pocket when the device is in the second position.

3. The device of claim 1, wherein the first arm extension comprises a first extension surface that contacts the friction ridge when the device is in the first position, and wherein the first lock arm comprises a first stop surface that contacts the stop plate when the device is in the first position.

4. The device of claim 3, wherein the friction ridge presses against the first extension surface causing the first stop surface to be tensioned against the stop plate to maintain the device in the first position.

5. The device of claim 1, wherein the stop plate is coupled to the first object via a living hinge.

6. The device of claim 1, wherein the first assembly and second assembly comprise Japanese steel.

7. The device of claim 1, wherein the first assembly is formed from a single sheet of steel, and wherein the second assembly is formed from a single sheet of steel.

8. The device of claim 7, wherein the first lock arm is substantially parallel to at least one of the first pin bridge, second pin bridge, stop plate and friction plate when the device is in the first position.

9. The device of claim 7, wherein the first lock arm is substantially perpendicular to at least one of the first pin bridge, second pin bridge, stop plate and friction plate when the device is in the second position.

10. The device of claim 1, further comprising a second lock arm coupled to the second object and having a second arm extension, wherein the second lock pin is coupled to the second lock arm, wherein the second arm extension forms a portion of the second lock arm that is most distal to the second object.

11. The device of claim 10, further comprising a second channel extending between the first lock arm and the second lock arm.

12. An eyewear hinge device that is movable between a first position and a second position, the device comprising:
a first assembly coupled to a first object, the first assembly having:
i. a first pin bridge and a second pin bridge which are both coupled to the first object, wherein the first pin bridge comprises a first pin aperture, and wherein the second pin bridge comprises a second pin aperture;
ii. a stop plate coupled to both pin bridges so that the stop plate is distal to the first object;
iii. a friction plate coupled to the first object and positioned between the pin bridges, and the friction plate extending towards the stop plate;
iv. a first channel extending around the friction plate separating the friction plate from the pin bridges and from the stop plate, wherein the friction plate comprises a friction pocket and a friction ridge, and wherein the friction ridge is positioned between the first object and the friction pocket; and
a second assembly coupled to a second object, the second assembly having:
i. a first lock arm and a second lock arm that are coupled to the second object, the first lock arm having a first lock pin and a first arm extension, and the second lock arm having a second lock pin and a second arm extension, wherein a second channel extends between the first lock arm and the second lock arm, wherein the lock pins extend away from each other, wherein the first arm extension forms a portion of the first lock arm that is most distal to the second object, wherein the second arm extension forms a portion of the second lock arm that is most distal to the second object, and wherein the first assembly is movably coupled to the second assembly by positioning the first lock pin in the first pin aperture and the second lock pin in the second pin aperture.

13. The device of claim 12, wherein the first arm extension comprises a first arm distal surface and the second arm extension comprises a second arm distal surface, are wherein the first arm distal surface and the second arm distal surface are both positioned in the friction pocket and the when the device is in the second position.

14. The device of claim 12, wherein the first arm extension comprises a first extension surface that contacts the friction ridge when the device is in the first position, wherein the second arm extension comprises a second extension surface that contacts the friction ridge when the device is in the first position, wherein the first lock arm comprises a first stop surface that contacts the stop plate when the device is in the first position, and wherein the second lock arm comprises a second stop surface that contacts the stop plate when the device is in the first position.

15. The device of claim 14, wherein the friction ridge presses against the first extension surface and the second extension surface causing the first stop surface and the second stop surface to be tensioned against the stop plate to maintain the device in the first position.

16. The device of claim 12, wherein the stop plate is coupled to the first object via a living hinge.

17. The device of claim 12, wherein the first assembly and second assembly comprise Japanese steel.

18. The device of claim 12, wherein the first assembly is formed from a single sheet of steel, and wherein the second assembly is formed from a single sheet of steel.

19. The device of claim 18, wherein the first lock arm is substantially parallel to at least one of the first pin bridge, second pin bridge, stop plate and friction plate when the device is in the first position.

20. The device of claim 18, wherein the first lock arm is substantially perpendicular to at least one of the first pin bridge, second pin bridge, stop plate and friction plate when the device is in the second position.
